(19) United States
(12) Patent Application Publication
(10) Pub. No.: US 2014/0318436 A1
(43) Pub. Date: Oct. 30, 2014

(54) PERFORATING SINGLE-USE IMPACT INDICATOR, FOR THE TRANSPORTATION OF FRAGILE PRODUCTS

(71) Applicant: Ronan SCHONBERG, (US)

(72) Inventor: Ronan Schonberg, Bourg-de-Thizy (FR)

(73) Assignee: Ronan Schonberg, Bourg-de-Thizy (FR)

(21) Appl. No.: 14/358,989

(22) PCT Filed: Nov. 16, 2012
(86) PCT No.: PCT/FR2012/000463

§ 371 Date: May 16, 2014

(30) Foreign Application Priority Data
Nov. 18, 2011 (FR) 1103527

(51) Int. Cl. G01L 5/00

(52) U.S. Cl. CPC G01L 5/0052
USPC 116/203

(57) ABSTRACT

A perforating single-use impact indicator consisting of three independent engaging dements: a perforating sealed container: a sensitive dement; content consisting of a plurality of associated components. The sensitive element in the collar of the perforating sealed container operates as a plug on the perforating sealed container in such a way that the said sensitive element can be activated directly or indirectly when the components forming the content have been mixed or moved subsequent to the deceleration caused by an impact to the package to which the impact indicator of the invention is attached. The visual appearance of the sensitive element definitively changes when in direct contact with one of the components forming the content or when subjected to a change in temperature or to a gas release resulting from the mixing or movement of the components forming the content.

Regardless of the efforts made by the packaging and transport industries to guarantee the integrity of packaged and transported equipment, the degradation of the equipment at the time of deliveries has never stopped being a problem for professionals, from an economic standpoint as well as in the organisation of the after-sales services.

Indeed, a piece of equipment that leaves the shipping department of a company in perfect operating condition and after several inspections, can be received by the recipient in a degraded and non-operational state.

The main stakeholders in the chain of delivery are generally insured for this type of situation but yet the responsibility of each of them has to be determined i.e.: the shipper, the carrier and the recipient.

This search for the truth is often rendered difficult by the fact that the recipient which is most often the consuming user, receives the package without opening it. This attitude cannot be reproached when it is known that certain materials and equipment are packaged in multiple and sophisticated packaging that is sometimes difficult to open and that deliverers are most often subjected to very tight schedules that do not allow them to wait for a complete inspection by the recipient.

It is therefore after the deliverer has left the destination location that the observations are made and the damage is noted but obviously not in the presence of the deliverer who is presumed to be responsible for said damage.

Aware of this disadvantage, the inventor of this invention has searched for a technical solution that would allow the receiver to visually observe that the package for which he is taking delivery has been mistreated and has been subjected to an impact that is sufficient to compromise the appearance or the operation of the equipment contained.

As such, observation of the mistreatment of the package during the transport can be carried out in the presence of the deliverer and endorsed by himself by signing the Delivery slip.

In searching for the solution, the inventor wanted the impact indicator to be visual but single-use, i.e. not able to be used again. When the package has been subjected to an impact, the impact indicator cannot in any case return to its initial state through any manipulation whatsoever which would annihilate its effect.

The inventor also searched for a means to render the impact indicator irremovable once the latter has been affixed to the package, in order to prevent the deliverer observing the activation of the indicator from replacing it with another non-activated indicator.

In order to simplify as much as possible the use of this technical solution, the inventor sought to design an impact indicator that is easy to use and therefore within reach of everyone, economical and effective regardless of its positioning on the package.

Most of the impact indicators that exist today on the market do not have such an association of favourable characteristics and are based on operating principles that are far removed from that of the invention of this patent.

As such, the patent most often cited in terms of signalling impacts on packages is a US patent issued on 5 Jan. 1988 and bearing registration number 32,570 which shall be designated hereinafter by the name of its inventor Worth. R.CONN such as Patent CONN.

This patent, is to be considered as an indicator of a change in position of the package rather than as an impact indicator. It is rather intended for packages that are to be transported in a well-determined position. Of course, most often the impacts are associated with changes in the position of the package, but a package can be seriously damaged without a change in its position. For example a package placed in a certain position can vertically receive on its upper surface a heavy weight able to deteriorate its contents without however changing its position. This can be the case for example of a package falling from the top of a pallet onto a package placed lower on said pallet. In such a case, the CONN patent cannot be effective ad detect the impact that has occurred.

The CONN patent which no longer being active can be opposed to this invention only in terms of prior art, has the characteristic of an operation based on the difference in density of two liquids.

As such, one of the two liquids with a lesser density than the other is maintained by difference in gravity in a housing specially designed to receive it. During a violent impact but rather during a turning over of the package, the low-density liquid leaves its initial housing and is positioned elsewhere and as such causes a visual change in place of the housing that was receiving it.

Although the concept makes it possible through a simple visualisation to observe that the package was mistreated, it is in no way single-use. Indeed, by supposing that the impact detector of the CONN patent has been affixed to a lateral wall or walls of the protected package and that said package has been subjected to an impact or a change in position sufficiently substantial to cause the detection, it remains possible for the deliverer to manipulate the package in such a way that the mass that has escaped from its receptacle returns to the latter.

In addition, as the product coming from the CONN patent is simply affixed using adhesive on one or several surfaces of the package, it remains able to be used again, which cannot be the case with the product of the invention of this patent.

The CONN patent also has the disadvantage of being able to be affixed only on the vertical surfaces of the package, contrary to the invention of this patent. Indeed, affixed to a horizontal surface of the package as for example the upper horizontal plane, the operation of it is entirely annihilated, with the effect of the difference in density and therefore of gravity of the two liquids contained becoming in fact inoperative.

Other existing methods are similar in the objective but not in the means of achieving it. Most of the existing methods make use of the mechanical movement of a mass inside a volume, for example British patent THOMAS no. WO 0037889 of Jun. 29, 2000 or the SHOCKWATCH patent no. WO 2008/085696 of Jul. 17, 2008, implemented today and of which it is possible to find the products on the market in various forms.

The method coming from this latter SHOCKWATCH patent is also based on the release during a violent impact or a change in position of the package, of a mass maintained imprisoned in a housing by means of a mobile part, inside a containing volume.

As such, during the impact or the change in position of the package provided, the mobile part maintaining the mass in its housing, is moved and releases the mass that disappears in the volume of the container. This movement leads to a different visibility of the initial zone and indicates the impact or the movement.

Many methods for indicating impact or movement have been imagined for other applications different from that of this invention, by making use of electricity or electronics. US Patent ZADESKI no. 2011/0100124 of May 5, 2011 entirely based on the movement of a metal mass establishing an electrical contact during impacts and movements of the protected object can be mentioned for example.

All of these methods that exist today cannot be opposed to the invention of this patent of which the operation is based on the mixing or the moving of several liquid volumes inside a container, with this mixing or moving acting on a sensitive element that changes appearance definitively.

This invention has for purpose to visually signal that a package that can appear to be in good condition has been subjected during its transport to one or more violent impacts able to alter the appearance or the operation of its content.

This invention relates to an impact indicator comprised of three independent engaging elements:

a) A perforating sealed container.

b) A sensitive element.

c) A content formed of one or several components.

According to the preferred embodiment of the invention, the perforating sealed container is manufactured from a material that is compatible with its use and preferably solid such as for example plastic material, metal or other rigid material on the market. It can also be made from a biodegradable material that will facilitate its elimination. It is formed of one or several parts, and is more preferably of cylindrical shape. One of these two ends is hermetically closed and of tapered shape, in order to allow for the introduction via perforation of the surface to which the container is attached, most often single- or double-flute packaging cardboard forming a package.

According to the preferred embodiment of the invention, the perforating sealed container has on its end opposite the sealed tapered end, a direct access to its inside volume, of a diameter preferably equivalent to the inner diameter of the container, in order to allow for the introduction into this volume of the content formed of the components added.

According to the preferred embodiment of the invention, the end opposite the tapered sealed end of the perforating sealed container is provided with a peripheral collar that is preferably cylindrical and flat, of low thickness and of a diameter that is sufficiently greater than the outer diameter of the container in order to allow for the support of the lower plane of said collar on the outer surface of the package, during the introduction of the container via perforation.

According to the preferred embodiment of the invention, the support collar of the perforating sealed container is designed in such a way that it can receive by introduction into its thickness or by application onto its thickness, a sensitive element more preferably cylindrical and of a diameter greater than the outer diameter of the perforating sealed container, most often formed by a pellet of low thickness.

According to the preferred embodiment of the invention, the inside volume of the perforating sealed container is plugged by the positioning of the sensitive element in or on the thickness of the collar.

Plugged as such, after the introduction into the inside volume of the component or components of the content, the sensitive element is directly accessible to direct contact with the content of the perforating sealed container.

According to the preferred embodiment of the invention, the upper plane of the collar provided with the sensitive element is protected from any external influence or degradation by an added protection most often formed or integrating a film made of transparent or translucent plastic material, allowing visual access to the sensitive element.

According to the preferred embodiment of the invention, the perforating sealed container has more preferably on one or the other of the surfaces formed by the lower plane of the collar and the external peripheral plane of the container, a special arrangement prohibiting the withdrawal of the impact indicator, without degrading the package whereon it was attached by perforation.

For example, the external peripheral surface of the container can have in an integrated or added manner, one or several non-return tabs able to penetrate the reception plane of the package during the setting up via perforation under vertical pressure and unable to be extracted from the package without visually observable degradation.

Through another example, the external peripheral surface of the container can have in an integrated or added manner, a helicoidal ramp preferably on a portion of its height, in such a way as to impose on the impact indicator a movement of rotation during the introduction via vertical pressure, a movement that would involve an opposite movement in order to extract the impact indicator, an opposite movement impossible to apply due to the very shape of the collar.

According to the preferred embodiment of the invention, the sensitive element is manufactured from a material compatible with its function and in particular from a material of which the appearance is modified substantially under the effect of a direct contact with one of the components, whether it be liquid, solid or gaseous or under the indirect effect of the consequence of the moving or of the mixing of the components together.

For example, the sensitive element of the invention is made from an absorbent material of which the appearance, shape or colour, changes automatically in contact with a wet component.

Through another example, the sensitive element of the invention is formed from a material of which the appearance, shape or colour, is automatically modified under the effect of an increase in temperature or in contact with a gas generated by the putting into contact of at least two components.

According to the preferred embodiment of the invention, the content of the perforating impact indicator is introduced into the perforating sealed container prior to the affixing of the sensitive element of the invention and the application of its external protection.

According to the preferred embodiment of the invention, the content of the perforating impact indicator is primarily composed of two solutions of which one is preferably formed of water and various additives such as pigments and preservatives and the other preferably formed of a fatty substance in liquid state, such as for example oil.

According to the preferred embodiment of the invention, during the introduction for example by gravity and via the upper access of the perforating sealed container, of components forming the content of the perforating impact indicator of the invention, the components are automatically placed and in agreement with their respective density in such a way that the component formed of water occupies the lower portion of the container which is the sharp portion of the latter and the component formed for example of oil, occupies the upper portion of the container which is the area separating the component formed of water from the sensitive element of the invention.

As such, the component formed of oil acts as a barrier prohibiting any contact between on the one hand the component formed of water and on the other hand the sensitive element of the invention.

According to the preferred embodiment of the invention, the operation of the impact indicator is based on the difference in density and in viscosity of the components of the content, which conditions their respective movement inside the perforating sealed container. As such, in case of an impact to the package provided with the impact indicator of the invention, the abrupt deceleration caused by the impact, upsets the stability of the two components and the component formed of water enters into full or partial direct contact with the sensitive element. Put into contact with the wet component, the sensitive element definitively changes appearance visually indicating the impact that has occurred.

According to the preferred embodiment of the invention, the inner diameter of the perforating sealed container, its surface condition and in particular its roughness are determined in close connection with the exact volume and the precise composition of each of the components. Indeed, it is these elements that determine with precision the setting of the indicator according to the results desired.

As such, the coordination of these various associated elements leads to prohibiting the operation of the impact indicator for impacts of low intensity often caused during the normal manipulations of a package and authorising it for more violent impacts able to result in the degradation of the packaged equipment.

For example, the ratio of the volumes between the two components conditions the effectiveness of the indicator. Indeed, the more the volume of the component formed of fatty substances is substantial, the less the impact indicator is sensitive. This is justified by the increase in the thickness of the fatty component and therefore of the barrier opposing the movement of the component formed of water.

According to a different embodiment of the invention, the perforating sealed container receives for example three components of which one is formed of water to which various additives have been added, the second is formed of a fatty substance such as oil and the third is formed of a chemical component in pellet or powder form, precisely dosed in order to react via the exothermal effect compatible with the preserving of the content, to the contact with humidity (for example Calcium oxide).

The sensitive element of the invention is itself formed of a thermal paper of which the external appearance is modified under the effect of an increase in temperature. Such a paper used for example in the device for transmitting faxes is known.

In this embodiment of the invention, through their respective density, the components are maintained in the perforating sealed container according to the following order:

The component formed of water is placed at the bottom and towards the tip of the container,

The component formed of a fatty substance is placed above the wet component.

The chemical component with exothermal effect is placed above the component formed of a fatty substance.

As such, the component formed of a fatty substance operates as a barrier between the wet component and the chemical component with exothermal effect.

During an impact to the package provided with the impact indicator of the invention, the abrupt deceleration caused by the impact, upsets the stability of the three components and the component formed of water enters into full or partial direct contact with the chemical component located under the sensitive element of the invention. Put into contact with the wet component, the chemical component generates a slight increase in the temperature inside the perforating sealed container, resulting in an immediate and definitive change in the appearance of the sensitive element.

As in the preceding embodiment of the invention, the inner diameter of the perforating sealed container, its surface condition and in particular its roughness are determined in close connection with the exact volume and the precise composition of each of the components. Indeed, it is these elements that determine with precision the setting of the indicator according to the results desired.

According to the preferred embodiment of the invention, the operation of the impact indicator of this patent is fundamentally based on the moving and the mixing of several associated components inside the perforating sealed container, with this moving or this mixing generating the transformation of the appearance of a sensitive element.

Many applications can be designed using this invention with respect to this definition.

The following description with regards to the annexed drawings by way of non-restricted examples, will make it possible to understand how the invention can be put into practice.

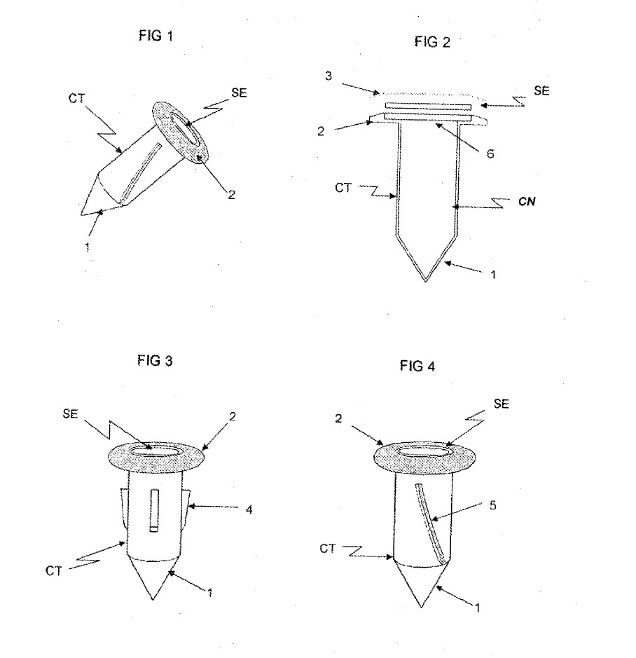

FIG. 1 is a perspective view of the indicator of the invention, ready to be applied to a package by perforation of the latter.

FIG. 2 is an exploded longitudinal cross-section view of the impact indicator of the invention empty of its content.

FIG. 3 is a view of the impact indicator of the invention provided with non-return tabs.

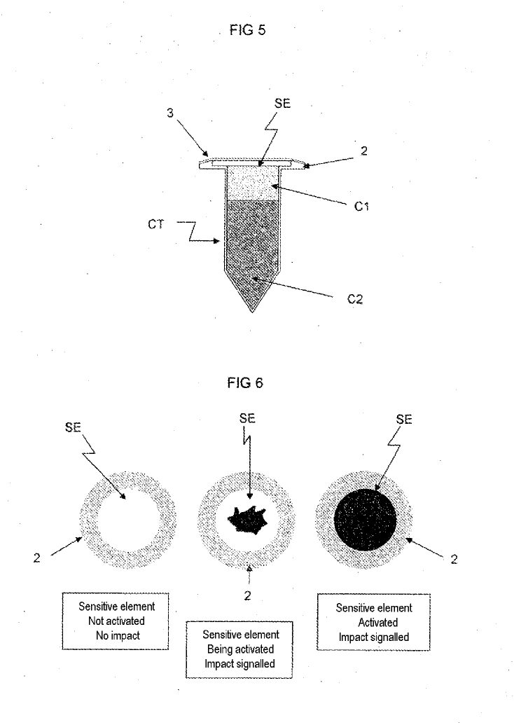

FIG. 4 is a view of the impact indicator of the invention provided with a helicoidal ramp.

FIG. 5 is a cross-section view of the impact indicator of the invention with its content and ready to be used.

FIG. 6 shows a top view of the sensitive element of the impact indicator of the invention in the three states of its operation.

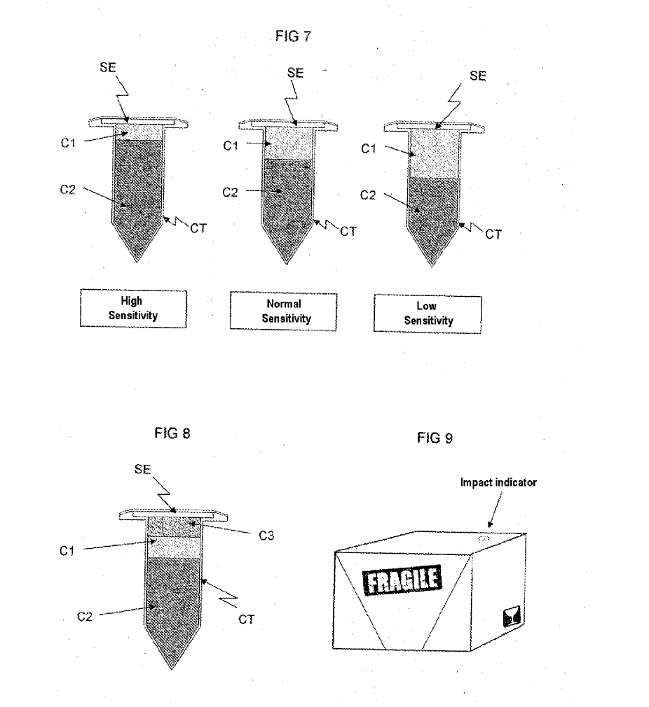

FIG. 7 shows respectively three different dosages of components forming the content and generating three different application conditions.

FIG. 8 is a cross-section view of the impact indicator of the invention formed for an operation via exothermal reaction making use of three components.

FIG. 9 shows a package provided with the impact indicator of the invention.

According to the preferred embodiment of the invention, the impact indicator of this invention is comprised of three independent engaging elements:

d) A perforating sealed container (CT)

e) A sensitive element (SE)

f) A content (CN) formed of one or several components

According to the preferred embodiment of the invention, the perforating sealed container (CT) is manufactured from a material compatible with its use. It is formed of one or several parts, and is more preferably of cylindrical shape. Once of its two ends is hermetically closed and is of tapered shape (1), in order to allow for the introduction by perforation of the surface to which the impact indicator of the invention is attached, most often single- or double-flute packaging cardboard forming a package. (See FIG. 1)

According to the preferred embodiment of the invention, the perforating sealed container (CT) has on its end opposite the sealed tapered end (1), a direct access to its inside volume (6) of diameter preferably equivalent to the inner diameter of the container (CT), in order to allow for the introduction into this volume of the added components forming the content (CN). (See FIG. 2).

According to the preferred embodiment of the invention, the end opposite the sealed tapered end (1) of the perforating sealed container (CT) is provided with a peripheral collar that is preferably cylindrical and flat (2), of low thickness and of a diameter sufficiently greater than the outer diameter of the container (CT) in order to allow for the support of the lower plane of said collar (2) on the outer surface of the package, during the introduction of the container (CT) via perforation. (See FIG. 1).

According to the preferred embodiment of the invention, the support collar (2) of the perforating sealed container (CT) is designed in such a way that it can receive by introduction into its thickness or by application onto its thickness, a sensitive element (SE) more preferably cylindrical and of a diameter greater than the outer diameter of the perforating sealed container (CT), most often formed of a pellet of low thickness. (See FIG. 2).

According to the preferred embodiment of the invention, the inside volume of the perforating sealed container (CT) is plugged by the positioning of the sensitive element (SE) in or on the thickness of the collar (2).

Plugged as such, after the introduction into the inside volume of the access (6) of the component or components of the content (CN), the sensitive element (SE) is directly accessible to direct contact with the content (CN) of the perforating sealed container (CT). (See FIG. 5)

According to the preferred embodiment of the invention, the upper plane of the collar (2) provided with the sensitive element (SE) is protected from any external influence or degradation by an added transparent or translucent protection (3), most often formed or integrating a film made of transparent or translucent plastic material, allowing visual access to the sensitive element (SE). (See FIG. 2).

According to the preferred embodiment of the invention, the perforating sealed container (CT) has more preferably on one or the other or on both surfaces formed by the lower plane of the collar (2) and the external peripheral plane of the container (CT), a special arrangement prohibiting the withdrawal of the impact indicator, without degrading the package whereon it was attached by perforation. (See FIGS. 3 and 4).

For example, the external peripheral surface of the container (CT) can have in an integrated or added manner, one or several non-return tabs (4) able to penetrate the reception plane of the package under the effect of a vertical pressure and unable to be extracted from the package without visually observable degradation. (See FIG. 3).

Through another example, the external peripheral surface of the container (CT) can have in an integrated or added manner, a helicoidal ramp (5) preferably on a portion of its height, in such a way as to impose on the impact indicator of the invention a movement of rotation during the introduction via vertical pressure, a movement that would involve an opposite movement in order to extract the impact indicator, an opposite movement rendered impossible to apply due to the very shape of the collar (2). (See FIG. 4).

According to the preferred embodiment of the invention, the sensitive element (SE) is manufactured from a material compatible with its function and in particular from a material of which the appearance is modified substantially under the effect of a direct contact with one of the components, whether it be liquid, solid or gaseous or under the indirect effect of the consequence of the moving or of the mixing of the components together.

For example, the sensitive element (SE) of the invention is made from an absorbent material of which the appearance, shape or colour, automatically changes in contact with a wet component. (See FIG. 6).

Through another example, the sensitive element (SE) of the invention is formed from a material of which the appearance, shape or colour, is automatically modified under the effect of an increase in temperature or in contact with a gas generated by the putting into contact of two components. (See FIG. 6).

According to the preferred embodiment of the invention, the content (CN) of the perforating impact indicator is introduced into the sealed container (CT) by the access (6) and prior to the affixing of the sensitive element (SE) of the invention and the application of its external protection (3). (See FIG. 2).

According to the preferred embodiment of the invention, the content (CN) of the perforating impact indicator is comprised mainly of two solutions (C1 and C2) of which one is preferentially formed of water and various additives such as pigments and preservatives (C2) and the other preferentially formed of a fatty substance in liquid state, such as for example oil (C1). (See FIG. 5).

According to the preferred embodiment of the invention, during the introduction for example by gravity and by the upper access (6) of the perforating sealed container (CT), of the components forming the content (CN) of the perforating impact indicator of the invention, the components (C1) and (C2) are automatically placed and in agreement with their respective density in such a way that the component formed of water (C2) occupies the lower portion of the container (CT) which is the sharp portion of the latter and the component formed for example of oil (C1), occupies the upper portion of the container (CT) which is the area separating the component formed of water (C2) from the sensitive element (SE) of the invention.

As such, the component formed of oil (C1) acts as a barrier prohibiting any contact between on the one hand the component (C2) formed of water and the sensitive element (SE) of the invention. (See FIG. 5).

According to the preferred embodiment of the invention, the operation of the impact indicator is based on the difference in density and in viscosity of the components (C1 and C2) of the content (CN), which conditions their respective movement inside the perforating sealed container (CT).

As such, in the case of an impact to the package provided with the impact indicator of the invention, the abrupt deceleration caused by the impact, upsets the stability of the two components (C1 and C2) and the component formed of water (C2) enters into full or partial direct contact with the sensitive element (SE). Put into contact with the wet component, the sensitive element (SE) definitively changes appearance visually indicating the impact that has occurred. (See FIG. 6).

According to the preferred embodiment of the invention, the inner diameter of the perforating sealed container (CT), its surface condition and in particular its roughness are determined in close connection with the exact volume and the precise composition of each of the components (C1 and C2). Indeed, it is these elements that determine with precision the setting of the indicator according to the results desired.

As such, the coordination of these various associated elements leads to prohibiting the operation of the impact indicator in inverted position or for impacts of low intensity often caused during the normal manipulations of a package and authorising it for more violent impacts able to result in the degradation of the packaged equipment.

For example, the ratio of the volumes between the two components (C1 and C2) conditions the effectiveness of the indicator. Indeed, the more the volume of the component formed of a fatty substance (C1) is substantial, the less the impact indicator is sensitive. This is justified by the increase in the thickness of the component formed of a fatty substance (C1) and therefore of the barrier opposing the movement of the component formed of water (C2). (See FIG. 7).

According to a different embodiment of the invention, the perforating sealed container (CT) receives for example three components (C1, C2 and C3) of which one is formed of water to which various additives have been added (C2), the second is formed of a fatty substance such as oil (C1) and the third is formed of a chemical component in pellet or powder form reacting via exothermal effect in contact with humidity (C3) (for example Calcium oxide). The sensitive element (SE) of the invention is itself formed of a thermal paper of which external appearance is modified under the effect of an increase in temperature. Such a paper used for example in the device for transmitting faxes is known.

In this embodiment of the invention, through their respective density, the components (C1, C2 and C3) are maintained in the perforating sealed container (CT) according to the following order:

The component formed of water (C2) is placed at the bottom and towards the tip (1) of the container (CT),

The component formed of a fatty substance (C1) is placed above the wet component (C2).

The chemical component with exothermal effect (C3) is placed above the component formed of a fatty substance (C1).

As such, the component formed of a fatty substance (C1) operates as a barrier between the wet component (C2) and the chemical component with exothermal effect (C3).

During an impact to the package provided with the impact indicator of the invention, the abrupt deceleration caused by the impact, upsets the stability of the three components (C1, C2 and C3) and the component formed of water (C2) enters into full or partial direct contact with the chemical component (C3) located under the sensitive element (SE) of the invention. Put into contact with the wet component (C2), the chemical component (C3) generates via exothermal effect a slight increase in the temperature inside the perforating sealed container (CT), resulting in the immediate and definitive change in appearance of the sensitive element (SE).

As in the preceding embodiment of the invention, the inner diameter of the perforating sealed container (CT), its surface condition and in particular its roughness are determined in close connection with the exact volume and the precise composition of each of the components (C1, C2 and C3) forming the content (CN). Indeed, it is these elements that determine with precision the setting of the indicator according to the results desired. (See FIG. 8).

According to the preferred embodiment of the invention, the operation of the impact indicator object of this patent is fundamentally based on the moving and/or the mixing of several components forming the contents (CN) inside the perforating sealed container (CT), with this moving or this mixing generating the definitive transformation of the appearance of a sensitive element (SE).

Many applications can be designed using this invention with respect to this definition.

1-7. (canceled)

8. Perforating single-use impact indicator comprising three independent engaging elements, namely:
a perforating sealed container;
a sensitive element; and
a content in the container comprising several associated components.

9. Perforating single-use impact indicator according to claim 8, wherein the perforating sealed container has a tapered end to facilitate its introduction by perforation of the wall of a package to which it will be attached and at its end opposite the tapered end, a collar to which is attached in an integrated manner into its thickness or added onto its thickness, a sensitive element operating as a plug of an access of the container and which is activated by the direct or indirect effect of the mixing or moving of the components comprising the content.

10. Perforating single-use impact indicator as claimed in claim 8, wherein the sensitive element is an element that changes visual appearance when it is subjected to a change in temperature or a gas release subsequent to a mixing or moving of the components of the content, resulting from a deceleration caused by an impact to a package to which the impact indicator is attached.

11. Perforating single-use impact indicator as claimed in claim 8, wherein the sensitive element is an element that changes visual appearance when it is placed in direct contact with one of the components of the content, subsequent to a mixing or the moving of the components of the content as a result of a deceleration caused by an impact to a package to which the impact indicator of the invention is attached.

12. Perforating single-use impact indicator as claimed in claim 10, wherein any change in visual appearance of the sensitive element is definitive and consequently renders the impact indicator not able to be reused.

13. Perforating single-use impact indicator as claimed in claim 8, wherein the perforating sealed container includes one or more mechanical elements arranged to prohibit withdrawal of the impact indicator from a package to which it has been introduced by perforation.

14. Perforating single-use impact indicator as claimed in claim 9, wherein the sensitive element attached to the collar is protected from any external intervention or alteration by an added transparent or translucent element.

15. Perforating single-use impact indicator as claimed in claim 11, wherein any change in visual appearance of the sensitive element is definitive and consequently renders the impact indicator not able to be reused.
